(19) United States
(12) Patent Application Publication
(10) Pub. No.: US 2026/0341832 A1
(43) Pub. Date: Oct. 29, 2026

(54) BATTERY DEVICE

(71) Applicant: LG ENERGY SOLUTION, LTD., Seoul (KR)

(72) Inventor: Hao Wen CHENG, Taipei City (TW)

(73) Assignee: LG ENERGY SOLUTION, LTD., Seoul (KR)

(21) Appl. No.: 19/111,579

(22) PCT Filed: Apr. 24, 2023
(86) PCT No.: PCT/KR2023/005563

§ 371 Date: Mar. 13, 2025

(30) Foreign Application Priority Data
Nov. 25, 2022 (KR) 10-2022-0160261

(51) Int. Cl. H01M 10/6554; H01M 10/623; H01M 10/647; H01M 10/653; H01M 50/211; H01M 50/247; H01M 50/293

(52) U.S. Cl. CPC H01M 10/6554; H01M 10/623; H01M 10/647; H01M 10/653; H01M 50/211; H01M 50/247; H01M 50/293

(57) ABSTRACT

Discussed is a battery device, which can include a stacked battery unit having two surfaces facing each other; two support frames provided on the two surfaces of the stacked battery unit, respectively, to partially expose the two surfaces; two thermally conductive adhesive layers respectively provided on the two surfaces of the stacked battery unit exposed by the two support frames; and two thermally conductive plates respectively provided on the two support frames and respectively fixed on the stacked battery unit through the two thermally conductive adhesive layers.

### TECHNICAL FIELD

The present disclosure relates to an electronic component, more particularly, to a battery device. The present application claims priority to Korean Patent Application No. 10-2022-0160261 filed on Nov. 25, 2022 in the Republic of Korea, the disclosure of which is incorporated herein by reference.

### BACKGROUND ART

Portable electronic products (e.g., notebook computers) can provide the required power by including a battery device. However, battery devices generate heat during operation, which affects the efficacy of the electronic products. Therefore, an effective method for improving the heat dissipation efficiency of battery devices is emerging as a challenge to be solved.

### DISCLOSURE

### Technical Problem

The present disclosure is directed to providing a battery device with excellent heat dissipation effect.

### Technical Solution

In one aspect of the present disclosure, there is provided a battery device, including: a stacked battery unit having two surfaces facing each other; two support frames provided on the two surfaces of the stacked battery unit, respectively, to partially expose the two surfaces; two thermally conductive adhesive layers respectively provided on the two surfaces of the stacked battery unit exposed by the two support frames; and two thermally conductive plates respectively provided on the two support frames and respectively fixed on the stacked battery unit through the two thermally conductive adhesive layers.

In an embodiment of the present disclosure, the stacked battery unit can include a first battery unit; a second battery unit; and a support layer provided between the first battery unit and the second battery unit.

In an embodiment of the present disclosure, the first battery unit and the second battery unit can include a soft pack battery cell, respectively.

In an embodiment of the present disclosure, a material of the support layer can include a plastic.

In an embodiment of the present disclosure, a material of each support frame can include a plastic.

In an embodiment of the present disclosure, each of the two thermally conductive adhesive layers can have a thickness in a range of approximately 0.125 mm to 0.5 mm.

In an embodiment of the present disclosure, a thermal conductivity of each thermally conductive plate can be greater than a thermal conductivity of each thermally conductive adhesive layer.

In an embodiment of the present disclosure, a material of each thermally conductive plate can include stainless steel.

In an embodiment of the present disclosure, each of the two thermally conductive plates can have a thickness in a range of approximately 0.05 mm to 0.2 mm.

In an embodiment of the present disclosure, the battery device can further include two printing layers respectively provided on the two thermally conductive plates to cover the two thermally conductive plates.

In an embodiment of the present disclosure, the two printing layers can be outermost layers of the battery device.

In an embodiment of the present disclosure, the two thermally conductive adhesive layers can overlap each other.

### Advantageous Effects

As described above, in the battery device according to the present disclosure, the thermally conductive plate is fixed on the stacked battery unit through a thermally conductive adhesive layer, which corresponds to the surface of the stacked battery unit to increase the heat dissipation area of the stacked battery unit and is advantageous for heat dissipation of the stacked battery unit. In addition, the stacked battery unit provides a good thermal conduction path through the thermally conductive adhesive layer and the thermally conductive plate, so that the temperature of the stacked battery unit is balanced and has desirable thermal stability. Therefore, the battery device according to the present disclosure has a desirable heat dissipation effect and allows the stacked battery unit to have desirable thermal stability.

### DESCRIPTION OF DRAWINGS

FIG. 1 is a diagram showing a battery device according to an embodiment of the present disclosure.

### BEST MODE

In order to understand the features and advantages of the present disclosure more clearly and easily, a detailed description is provided in conjunction with the drawings through the following embodiment.

The present disclosure can be understood by referring to the following detailed description and the accompanying drawings, and it should be noted that for easy understanding of the present disclosure and conciseness of the drawings, the structures in the drawings are not drawn to scale. In addition, the quantity and size of each component in the drawing is only an example and does not limit the present disclosure.

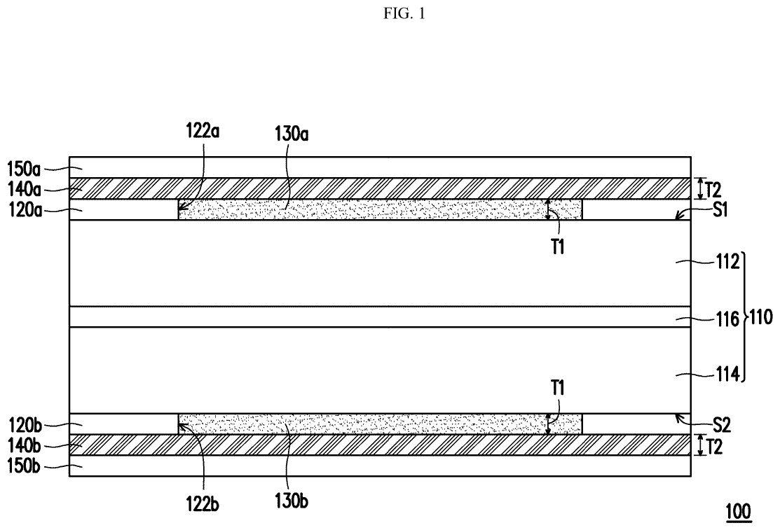

FIG. 1 is a diagram showing a battery device according to an embodiment of the present disclosure.

According to FIG. 1, in this embodiment, a battery device 100 includes one stacked battery unit 110, two support frames 120a and 120b, two thermally conductive adhesive layers 130a and 130b, and two thermally conductive plates 140a and 140b. The stacked battery unit 110 has two surfaces S1 and S2 facing each other. The support frames 120a and 120b are located on the surfaces S1 and S2 of the stacked battery unit 110, respectively, and partially expose the surfaces S1 and S2, respectively.

Further, the thermally conductive adhesive layers 130a and 130b are respectively provided on the surfaces S1 and S2 of the stacked battery unit 110 exposed by the support frames 120a and 120b. The thermally conductive plates 140a and 140b are provided on the support frames 120a and 120b, respectively, and are fixed on the stacked battery unit 110 through the thermally conductive adhesive layers 130a and 130b, respectively.

In detail, the battery device 100 according to this embodiment is a battery device used in a notebook computer or other electronic products, but is not limited thereto. The stacked battery unit 110 includes a first battery unit 112, a second battery unit 114, and a support layer 116, among which the support layer 116 is provided between the first battery unit 112 and the second battery unit 114. In the first embodiment, each of the first battery unit 112 and the second battery unit 114 can be a soft pack battery cell. In one embodiment, the material of the support layer 116 can be plastic, for example, polycarbonate (PC), but is not limited thereto. In one embodiment, the thickness of the support layer 116 can be 0.2 mm, but is not limited thereto.

Referring to FIG. 1 again, in this embodiment, the support frames 120a and 120b include openings 122a and 122b, respectively, and the material of each of the support frames 120a and 120b is plastic, such as polycarbonate, but is not limited thereto. In one embodiment, the thickness of each of the support frames 120a and 120b is 0.2 mm, but is not limited thereto.

In addition, the thermally conductive adhesive layers 130a and 130b in this embodiment are provided in the openings 122a and 122b of the support frames 120a and 120b, respectively, and directly contact the surfaces S1 and S2 of the stacked battery unit 110 exposed by the support frames 120a and 120b.

In one embodiment, the thickness T1 of each of the thermally conductive adhesive layers 130a and 130b is in the range of, for example, 0.125 mm to 0.5 mm. In one embodiment, the thermally conductive adhesive layers 130a and 130b can be, for example, 3M adhesives having a thermal conductivity of 0.6 W/mK, such as 3 M™8805 (0.125 mm thickness), 3M™ 8810 (0.25 mm thickness), 3 M™8815 (0.375 mm thickness), or 3M™8820 (0.5 mm thickness) module, but is not limited thereto.

In one embodiment, the thermally conductive adhesive layers 130a and 130b fill the openings 122a and 122b of the support frames 120a and 120b and are cut to coincide with the openings 122a and 122b. In one embodiment, the thermally conductive adhesive layers 130a and 130b can fill the openings 122a and 122b of the support frames 120a and 120b and extend onto the support frames 120a and 120b.

In addition, the thermally conductive plates 140a and 140b according to this embodiment are specifically flat, and the thermal conductivity of each of the thermally conductive plates 140a and 140b is greater than the thermal conductivity of each of the thermally conductive adhesive layers 130a and 130b.

In one embodiment, the material of each of the thermally conductive plates 140a and 140b can be stainless steel, for example, stainless steel 304 or stainless steel 316, and the thermal conductivity of stainless steel 304 and stainless steel 316 is 16.3 W/m°C, respectively. The thickness T2 of each of the thermally conductive plates 140a and 140b is in the range of 0.05 mm to 0.2 mm.

When the thermally conductive plates 140a and 140b are made of stainless steel 304, the thickness T2 is preferably 0.1 mm, and when the thermally conductive plates 140a and 140b are made of stainless steel 316, the thickness T2 is preferably 0.15 mm.

In addition, the battery device 100 according to this embodiment also includes two printing layers 150a and 150b, and the printing layers 150a and 150b are provided on the thermally conductive plates 140a and 140b, respectively, to cover the thermally conductive plates 140a and 140b. The printing layers 150a and 150b can include text or image, and display information such as a model of the battery device 100. Accordingly, the printing layers 150a and 150b can also be referred to as label layers. In one embodiment, the thickness of the printing layers 150a and 150b is 0.1 mm, for example.

As described above, in the battery device according to the present disclosure, the thermally conductive plate is fixed on the stacked battery unit through a thermally conductive adhesive layer, which corresponds to the surface of the stacked battery unit and increases the heat dissipation area of the stacked battery unit. Therefore, it is advantageous for heat dissipation of the stacked battery unit.

In addition, the stacked battery unit also provides a good thermal conduction path through the thermally conductive adhesive layer and the thermally conductive plate so that the temperature of the stacked battery unit is balanced to have desirable thermal stability. Therefore, the battery device according to the present disclosure has a good heat dissipation effect (temperature drop by at least 3 °C) and allows the stacked battery unit to have desirable thermal stability.

The present disclosure has been described through the embodiment as described above, but is not limited thereto, and appropriate changes and modifications can be made by those skilled in the art within the range that does not deviate from the purpose of the present disclosure, and the scope of protection of the present disclosure shall be based on the appended claims.

### REFERENCE NUMERALS

100: battery device
110: stacked battery unit
112: first battery unit
114: second battery unit
116: support layer
120a, 120b: support frame
122a, 122b: opening
130a, 130b: thermally conductive adhesive layer
140a, 140b: thermally conductive plate
150a, 150b: printing layer
S1, S2: surface
T1, T2: thickness

1. A battery device, comprising:
a stacked battery unit having two surfaces facing each other;
two support frames provided on the two surfaces of the stacked battery unit, respectively, to partially expose the two surfaces;
two thermally conductive adhesive layers respectively provided on the two surfaces of the stacked battery unit exposed by the two support frames; and
two thermally conductive plates respectively provided on the two support frames and respectively fixed on the stacked battery unit through the two thermally conductive adhesive layers.

2. The battery device according to claim 1,
wherein the stacked battery unit includes:
a first battery unit;
a second battery unit; and
a support layer provided between the first battery unit and the second battery unit.

3. The battery device according to claim 2,
wherein the first battery unit and the second battery unit include a soft pack battery cell, respectively.

4. The battery device according to claim 2,
wherein a material of the support layer includes a plastic.

5. The battery device according to claim 1,
wherein a material of each support frame includes a plastic.

6. The battery device according to claim 1,
wherein each of the two thermally conductive adhesive layers has a thickness in a range of approximately 0.125 mm to 0.5 mm.

7. The battery device according to claim 1,
wherein a thermal conductivity of each thermally conductive plate is greater than a thermal conductivity of each thermally conductive adhesive layer.

8. The battery device according to claim 1,
wherein a material of each thermally conductive plate includes stainless steel.

9. The battery device according to claim 1,
wherein each of the two thermally conductive plates has a thickness in a range of approximately 0.05 mm to 0.2 mm.

10. The battery device according to claim 1, further comprising:
two printing layers respectively provided on the two thermally conductive plates to cover the two thermally conductive plates.

11. The battery device according to claim 10, wherein the two printing layers are outermost layers of the battery device.

12. The battery device according to claim 1, wherein the two thermally conductive adhesive layers overlap each other.
